(19) United States
(12) Patent Application Publication
(10) Pub. No.: US 2011/0149599 A1
(43) Pub. Date: Jun. 23, 2011

(54) Illuminated Housing Cover for Mobile Communication Device

(75) Inventors: Chenyu Wei, Beijing (CN); Jason Xing, Beijing (CN)

(73) Assignee: Sony Ericsson Mobile Communications AB, Lund (SE)

(21) Appl. No.: 12/752,263

(22) Filed: Apr. 1, 2010

(30) Foreign Application Priority Data
Dec. 18, 2009 (CN) 200910249094.5

(51) Int. Cl. F21V 8/00; G02B 6/00

(52) U.S. Cl. 362/611; 264/1.24

(57) ABSTRACT

An illuminated housing cover includes a light guide and light source sandwiched between an outer light transmissive layer and an inner layer. The light source is disposed at one end of the light guide and arranged so that the emitted light enters one end of the light guide. A light mask is disposed between the light guide and the outer light transmissive layer to generate a desired lighting effect or light pattern. The housing cover can be manufactured using a two-step molding process.

### RELATED APPLICATION

This application claims the benefit under 35 U.S.C. §119 of Chinese Application Number 200910249094.5, filed in China on Dec. 18, 2009. That application, which is entitled “Illuminated Housing Cover for Mobile Communication Device,” is incorporated herein by reference in its entirety.

### BACKGROUND

The present invention relates generally to housings for mobile communication devices and, more particularly, to housings for mobile communication devices having integrated illumination effects. Mobile communication devices, such as mobile telephones, personal digital assistants, and smart phones, have become ubiquitous components of modern life. For many consumers, aesthetics are an important consideration in the selection of a mobile communication device for personal use. Handsome aesthetics not only make the phone attractive to the user, but also provide a means of personal expression to the user. Accordingly, most manufacturers of mobile communication devices continue to search for ways to enhance the aesthetics appeal of their mobile communication devices to consumers. Incorporating illumination or lighting effects into mobile communication devices is one way to enhance the aesthetics of the mobile communication device. Illuminated covers and housings for mobile communication devices are known. More particularly, it is known to place a light source inside the housing for emitting light that passes through a translucent cover to produce a soft glowing effect.

Several problems may be encountered when trying to add illumination or lighting effects to a mobile communication device. First, as the form factor of the mobile communication device decreases, there is less space to accommodate the light source and light guides needed to implement lighting effects. Further, the battery and other components within the mobile communication device cab block light and make it difficult to add illumination effects to some components, such as the battery cover. Accordingly, there continues to be a need for new ways to create lighting effects that can be accommodated in mobile communication devices with small form factors.

### SUMMARY

The present invention relates to a housing cover for a mobile communication device having integrated illumination. The housing cover has a sandwich construction made using a two-shot injection molding process. The housing cover includes a light guide and light source sandwiched between an outer light transmissive layer and an inner layer. The light source is disposed at one end of the light guide and arranged so that the emitted light enters one end of the light guide. A light mask is disposed between the light guide and the outer light transmissive layer to generate a desired lighting effect or light pattern. Because the light guide and light source are integrally formed with the housing cover during the molding process, it is possible to achieve virtually any lighting effect within a very small form factor. Further, the light will not be obstructed by batteries or other internal components of the mobile communication device.

Exemplary embodiments of the invention comprise a molded housing cover for a mobile communication device. In one embodiment, the molded housing cover comprises an outer light transmissive layer and an inner layer formed into a unitary component by a multi-shot molding process. A light guide and light source is sandwiched between the outer light transmissive layer and the inner layers during the multi-shot molding process. A light mask between the light transmissive outer layer and the light transmissive outer layer allows light to exit through the cover in a desired pattern.

In some embodiments, the light guide is in surface-to-surface contact with the outer light transmissive layer and the inner layer.

In some embodiments, the outer light transmissive layer comprises a recess for receiving the light source.

In some embodiments, the light source comprises a circuit board insertable into the recess in the outer light transmissive layer and a light source arranged to direct light into one end of the light guide.

In some embodiments, the inner layer comprises an opening exposing contacts on the printed circuit board.

In some embodiments, the light mask comprises a light blocking paint applied in a pattern to one of the outer light transmissive layer and the light guide.

In some embodiments, the light mask comprises a film disposed between the outer light transmissive layer and the light guide.

Other embodiments of the invention comprise methods of manufacturing a light transmissive housing cover for a mobile communication device. One exemplary method comprises molding an outer light transmissive layer of the housing cover during a first molding step; molding an inner layer of the housing cover during a second molding step such that the outer transmissive layer and inner layer form a unitary component; sandwiching a light guide and light source between outer transmissive layer and inner layer during the second molding step; and forming a light mask between the outer light transmissive layer and the light guide.

In some embodiments, sandwiching a light guide and light source between outer transmissive layer and inner layer during the second molding step comprises inserting a light guide and light source into the mold adjacent an inside surface of the outer light transmissive layer following the first molding step.

Some embodiments further comprise forming, during the first molding step, a recess in the outer light transmissive layer to receive the light source.

In some embodiments, inserting a light guide and light source into the mold adjacent an inside surface of the outer light transmissive layer comprises inserting the light source into the recess formed in the outer light transmissive layer during the first molding step.

In some embodiments, molding an inner layer of the housing cover comprises molding the inner layer with an opening to expose contacts connected to the light source.

In some embodiments, forming a light mask between the outer light transmissive layer and the light guide comprises applying a light blocking coating to one of the outer light transmissive layer and the light guide.

In some embodiments, forming a light mask between the outer light transmissive layer and the light guide comprises inserting a light blocking film having a pattern of openings between the outer light transmissive layer and the light guide.

### BRIEF DESCRIPTION OF THE DRAWINGS

FIG. 1 is a schematic section view of an illuminated housing cover according to one embodiment of the invention.

FIG. 2 illustrates the main process steps in the manufacturing of the illuminated housing cover.

FIG. 3 illustrates the outer transmissive layer of the housing cover after the first molding step.

FIG. 4 illustrates the outer transmissive layer of the housing cover after the light mask is applied.

FIG. 5 illustrates the insertion of the light guide and light source into the mold adjacent the outer transmissive layer of the housing cover.

FIG. 6 illustrates the housing cover after the final molding step.

### DETAILED DESCRIPTION

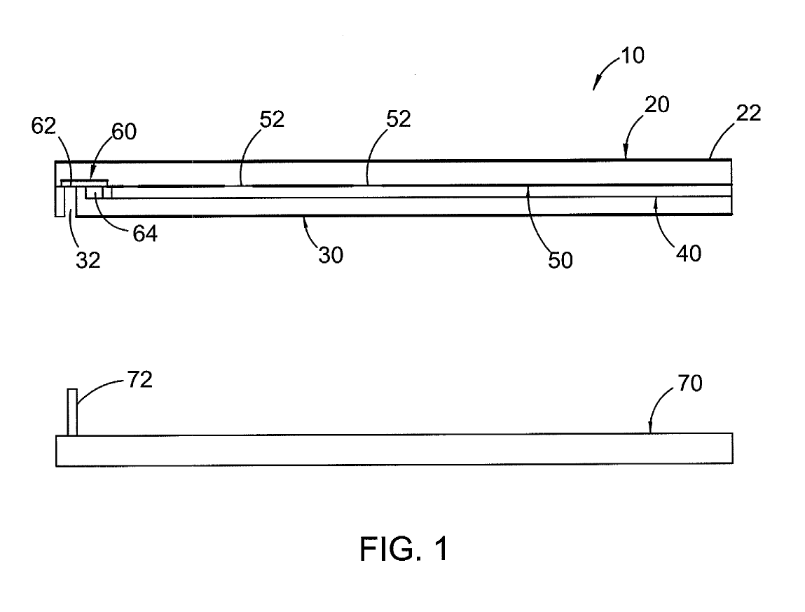

Referring now to the drawings, FIG. 1 schematically illustrates a housing cover 10 according to one exemplary embodiment of the present invention. The housing cover 10 may comprise, for example, a front cover, back cover, or battery cover of a mobile communication device. As used herein, the term “mobile communication device” refers to any handheld or portable electronic device that is capable of communicating wirelessly with other devices. The term “mobile communication device” includes, without limitation, mobile telephones, personal digital assistants, smart phones, laptop computers, handheld computers, and other devices with wireless communication capabilities.

The housing cover 10 is a unitary structure with a sandwich construction made using a two-shot molding process. The main components of the housing cover 10 comprise an outer light transmissive layer 20, an inner layer 30, light guide 40, light mask 50, and light source 60. The outer light transmissive layer 20 is made preferably with a transparent or translucent polycarbonate material, while the inner layer 30 may be made using an opaque polycarbonate or other plastic material. The light guide 40 is made from an optically-transmissive material. The light guide 40 and light source 60 are sandwiched between the outer light transmissive layer 20 and inner layer 30. The light mask 50 is disposed between the light guide 40 and outer light transmissive layer 20 and has a pattern of light transmissive openings that define a lighting pattern. The light source 60 may comprise, for example, a side-fired LED that directs light into one end of the light guide 40. The emitted light is transmitted along the light guide 40. The light is reflected or scattered at desired points to emit the light through the outer transmissive layer 20. Electrical connection with a main circuit board 70 can be made, for example, by a conductive pin 72 that extends from the main circuit board 70 to make contact with light source 60.

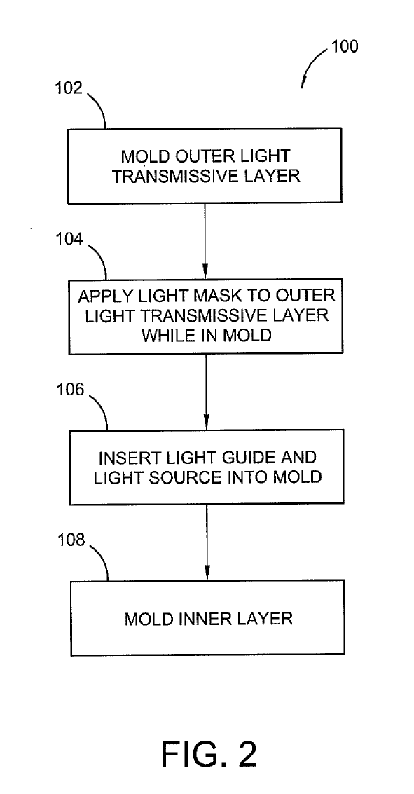

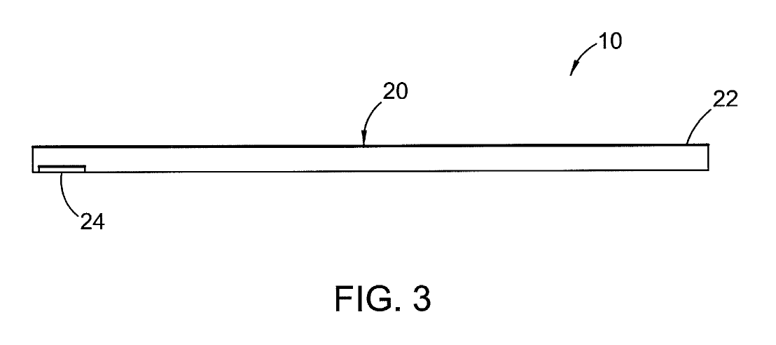

FIG. 2 illustrates the main steps in the process 100 for manufacturing the illuminated housing cover 10. In the first step, the outer light transmissive layer 20 is formed by injection molding. As previously noted, the outer light transmissive layer 20 may be made from a transparent polycarbonate material. FIG. 3 illustrates the outer light transmissive layer 20 after the initial molding step. A recess 24 is formed in the inner surface at one end of the outer light transmissive layer 20. As described in greater detail below, the recess 24 receives a printed circuit board (PCB) for the light source 60. A transparent paint 22 is applied to the outer surface of the outer layer 20 during the molding process using well-known coating techniques.

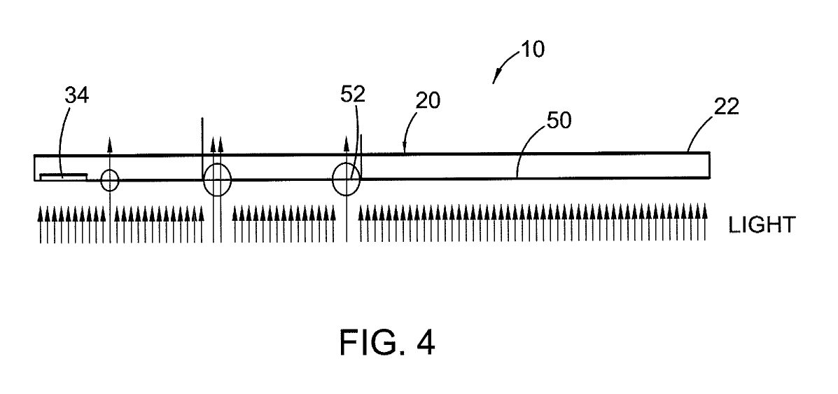

In the second step of the manufacturing process shown in FIG. 2, the light mask 50 is applied to the inner surface of the outer light transmissive layer 20. The light mask 50 may, for example, comprise an opaque paint or other coating that blocks light transmission. FIG. 4 illustrates the outer transmissive layer 20 after the light mask 50 is applied. The light mask 50 includes a pattern of openings or voids 52 where light is allowed to pass through the light mask 50. The openings 52 can be shaped and/or positioned to achieve any desired lighting effect or pattern. While the exemplary embodiment shows the light mask 50 applied to the outer light transmissive layer 20, those skilled in the art will appreciate that the light mask 50 may be applied to the outer light transmissive layer 20 while it remains in the mold.

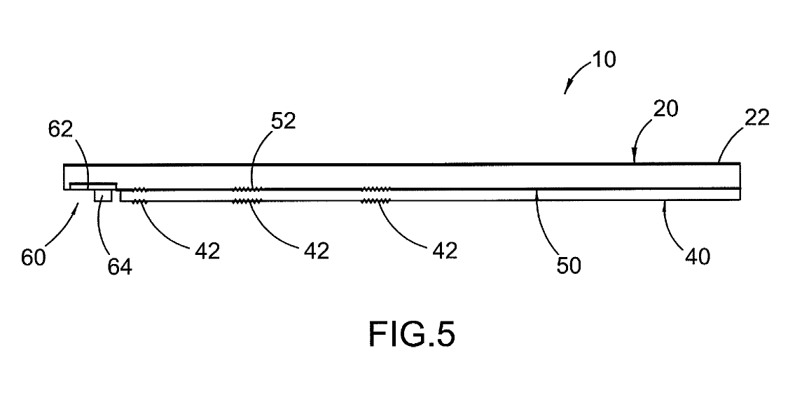

In the third step of the manufacturing process shown in FIG. 2, the light guide 40 and light source 60 are inserted into the injection mold containing the outer light transmissive layer 20. FIG. 5 illustrates the insertion of the light source and light guide into the mold. The light guide 40 comprises a generally planar member made of an optically transmissive material. The light guide 40 includes light reflecting or light scattering features 42 to reflect or scatter light through the openings 52 in the light mask 50. The light source 60 comprises a side-fired light-emitting diode (LED) mounted on a printed circuit board 62. The printed circuit board includes electrical contacts for making electrical connection with the pin 72 on the main circuit board 70. The LED is arranged to emit light into one end of the light guide 40. The light travels along the light guide 40 and is scattered by the light reflecting or scattering features 42 through the openings 52 in the light mask 50.

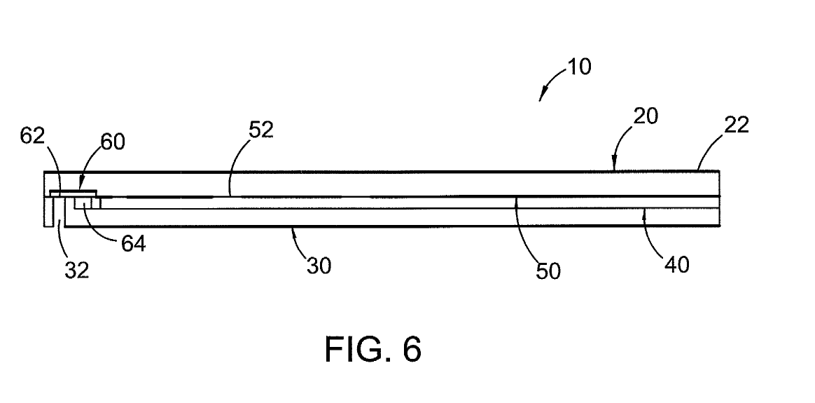

The fourth step in the manufacturing process shown in FIG. 2 is molding the inner layer 30 of the housing cover 10. The second molding operation encapsulates or sandwiches the light guide 40 and light source 60 between the outer light transmissive layer 20 and inner layer 30. FIG. 6 illustrates the housing cover 10 after the second molding step. The inner layer 30 of the housing cover 10 has an opening 32 at one end to expose the contacts on the printed circuit board 62 of the light source 60. The opening allows electrical connections to be made between the light source 60 and the main circuit board 70 of the mobile communication device. The second molding operation may be performed in the same injection mold used for the initial molding step. The completed housing cover 100 can be removed from the mold when the outer layer 30 cools.

When removed from the mold following the second molding step, the housing cover 10 comprises a unitary component with a sandwich construction. Because the light guide 40 and light source 60 are integrated into the housing cover 10, the housing cover 10 of the present invention solves the problem of integrating illumination into mobile communication devices with small form factors. Using the housing cover 10 of the present invention avoids the need to make space inside the housing to accommodate the light guide 40 and light source 60. Further, the integrated light guide 40 can deliver light to areas of the housing cover 10 that would otherwise be obstructed by the battery or other internal components of the mobile communication device 10.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A molded housing cover for a mobile communication device, said housing member comprising:
an outer light transmissive layer and an inner layer formed into a unitary component by a multi-shot molding process;
a light guide and light source sandwiched between the outer light transmissive layer and the inner layers during the multi-shot molding process; and
a light mask between the light transmissive outer layer and the light guide.

2. The molded housing cover of claim 1 wherein the light guide is in surface-to-surface contact with the outer light transmissive layer and the inner layer.

3. The molded housing cover of claim 1 wherein the outer light transmissive layer comprises a recess for receiving the light source.

4. The molded housing cover of claim 3 wherein the light source comprises a circuit board insertable into the recess in the outer light transmissive layer and a light source arranged to direct light into one end of the light guide.

5. The molded housing cover of claim 4 wherein the inner layer comprises an opening exposing contacts on the printed circuit board.

6. The molded housing cover of claim 1 wherein the light mask comprises a light blocking paint applied in a pattern to one of the outer light transmissive layer and the light guide.

7. The molded housing cover of claim 5 wherein the light mask comprises a film disposed between the outer light transmissive layer and the light guide.

8. A method of manufacturing a light transmissive housing cover for a mobile communication device, the method comprising:
molding an outer light transmissive layer of the housing cover during a first molding step;
molding an inner layer of the housing cover during a second molding step such that the outer transmissive layer and inner layer form a unitary component;
sandwiching a light guide and light source between outer transmissive layer and inner layer during the second molding step; and
forming a light mask between the outer light transmissive layer and the light guide.

9. The method of claim 8 wherein sandwiching a light guide and light source between outer transmissive layer and inner layer during the second molding step comprises inserting a light guide and light source into the mold adjacent an inside surface of the outer light transmissive layer following the first molding step.

10. The method of claim 8 further comprising forming, during the first molding step, a recess in the outer light transmissive layer to receive the light source.

11. The method of claim 10 wherein inserting a light guide and light source into the mold adjacent an inside surface of the outer light transmissive layer comprises inserting the light source into the recess formed in the outer light transmissive layer during the first molding step.

12. The method of claim 11 wherein molding an inner layer of the housing cover comprises molding the inner layer with an opening to expose contacts connected to the light source.

13. The method of claim 8 wherein forming a light mask between the outer light transmissive layer and the light guide comprises applying a light blocking coating to one of the outer light transmissive layer and the light guide.

14. The method of claim 8 wherein forming a light mask between the outer light transmissive layer and the light guide comprises inserting a light blocking film having a pattern of openings between the outer light transmissive layer and the light guide.
